(19) United States
(12) Patent Application Publication
(10) Pub. No.: US 2011/0066652 A1
(43) Pub. Date: Mar. 17, 2011

(54) CONDITIONAL ACCESS TO USER-GENERATED MULTIMEDIA CONTENT

(75) Inventors: David J. Piepenbrink, Chicago, IL (US); Lee M. Chow, Naperville, IL (US); James T. Sofos, Aurora, IL (US)

(73) Assignee: AT&T INTELLECTUAL PROPERTY I, L.P., Reno, NV (US)

(21) Appl. No.: 12/559,280

(22) Filed: Sep. 14, 2009

(51) Int. Cl. G06F 17/30

(52) U.S. Cl. 707/783; 707/E17.009

(57) ABSTRACT

A method and system for distributing multimedia content may enable a user to specify a number of recipients for receiving user-generated content (UGC) provided by a multimedia content distribution network (MCDN). The UGC may be stored in a UGC library. The recipients may be specified by selecting entries in an electronic address book accessible via the MCDN. The specified recipients may retrieve the UGC, or the UGC may be sent to the recipients. Access to the UGC may be provided by at least one of: a web access point, an Internet-protocol access point, and a mobile access point.

### BACKGROUND

1. Field of the Disclosure

The present disclosure relates to presenting assets related to multimedia content and, more particularly, to accessing libraries of multimedia content.

2. Description of the Related Art

Modern multimedia content distribution networks (MCDNs) provide a vast array of multimedia content assets. Users may generate their own multimedia content for distribution using network resources.

### BRIEF DESCRIPTION OF THE DRAWINGS

FIG. 1 is a block diagram of selected elements of an embodiment of an MCDN;

FIG. 2 is a block diagram of selected elements of an embodiment of an MCDN;

FIG. 3 is a block diagram of selected elements of an embodiment of an MCDN;

FIG. 4 is a block diagram of selected elements of an embodiment of an MCDN;

FIG. 5 is an embodiment of a method for presenting assets related to multimedia content; and

FIG. 6 illustrates an embodiment of a multimedia handling device (MHD).

### DESCRIPTION OF THE EXEMPLARY EMBODIMENTS

In one aspect, a disclosed method for distributing multimedia content in an MCDN may include displaying information describing user-generated content associated with a user of the MCDN, and enabling the user to select at least one recipient from entries in an electronic address book accessible via the MCDN. The method may further include enabling the user to authorize the at least one recipient to access the user-generated content via at least one of: a web portal, an Internet protocol television (IPTV) portal, and a mobile portal. The user may be associated with a registered account for the MCDN.

In certain embodiments, the method may further include enabling the user to specify a portion of the user-generated content for uploading to an MCDN server. The uploaded content may be stored in a user-generated content library. The MCDN server may be configured to display the selected at least one item to the at least one recipient via at least one of: the web portal, the IPTV portal, and the mobile portal. The method may still further include receiving user input selecting at least one item in the user-generated content, while the at least one recipient may only be authorized to access the selected at least one item.

In some embodiments, the method may include enabling the user to send the user-generated content to the at least one recipient. The electronic address book may include auto-populated entries for MCDN users. The electronic address book may include additional entries for non-MCDN users. The electronic address book may be provided by a business entity different from the provider of the MCDN.

In yet another aspect, a disclosed service for distributing multimedia content in an MCDN may include displaying information indicative of uploaded user-generated content associated with a user of the MCDN, and enabling the user to select an entry in an electronic address book accessible via the MCDN. The service may further include enabling the user to specify the entry for receiving the user-generated content via an IPTV portal. The user may be associated with a registered account for the MCDN.

In particular embodiments, the service may include enabling the user to select an item of user-generated content from the displayed information. The service may further include making the selected item of user-generated content available to the entry using a network address specified in the electronic address book. The network address may include an email address. The network address may include an MCDN network specifier. The network address may include an Internet-protocol address.

In yet another aspect, disclosed computer-readable memory media include executable instructions for implementing an MCDN according to the operations described herein. The instructions may be executable to enable a user to select a user-generated multimedia asset via at least one of an access portal included in the group: a web portal, an IPTV portal provided by the MCDN, and a mobile portal, and enable the user to specify an entry in an electronic address book for receiving the selected multimedia asset.

In certain embodiments, the memory media may further include instructions executable to display information indicative of the user-generated multimedia asset to the user. The memory media may still further include instructions executable to enable the user to upload the multimedia asset via at least one of the access portals, and store the uploaded multimedia asset in a user-generated multimedia content library. The memory media may also include instructions executable to access the electronic address book remotely via a network connection. The network connection may be within the MCDN.

In the following description, details are set forth by way of example to facilitate discussion of the disclosed subject matter. It should be apparent to a person of ordinary skill in the field, however, that the disclosed embodiments are exemplary and not exhaustive of all possible embodiments.

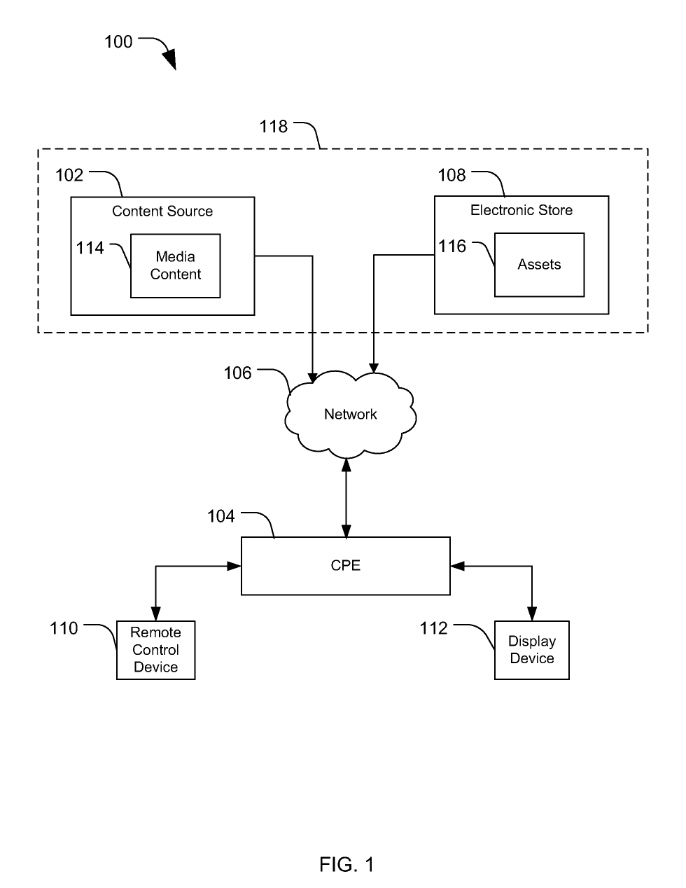

FIG. 1 is a block diagram of a particular illustrative embodiment of system 100 to present assets related to media content. System 100 includes content source 102 that communicates with customer premises equipment (CPE) 104 (which may include, for example, a set-top box (STB) device) via network 106. Content source 102 includes a memory to store media content 114. Media content 114 may include user-generated content. CPE 104 can receive input from remote control device 110 and can communicate audio and video to display device 112. In a particular embodiment, network 106 may be a public network, such as the Internet, or a private access network, such as an MCDN.

Content source 102 and CPE 104 can communicate with electronic store server 108 via network 106. Electronic store server 108 includes data related to one or more assets 116, which may be related to media content 114. In an illustrative embodiment, server system 118 can include both content source 102 and electronic store server 108, providing a single interface for media content distribution and for presenting assets related to the media content.

In one embodiment, server system 118 receives a request for an electronic storefront from a destination device, such as CPE 104. Server system 118 can identify media content received at CPE 104 based on the request or based on data from content source 102. Server system 118 (or electronic store server 108) can generate an electronic storefront that includes selectable indicators related to assets selected from assets 116 based on the media content. In certain embodiments, assets 116 can include data related to physical assets and electronic assets that are related to the media content. For example, the physical assets may include articles of clothing (hats, shirts, jackets, other articles of clothing, or any combination thereof), posters (movie posters, actor photographs, other images, or any combination thereof), soundtracks (e.g., compact discs (CDs)), other physical products, or any combination thereof. The electronic assets can include digital wallpaper (movie images, actor images, other images, or any combination thereof), ring tones (audio clips from media content, soundtrack clips, other audio clips, or any combination thereof), downloadable soundtracks, Video on Demand (VOD) content, video clips, other electronic assets, or any combination thereof. In general, each of the assets may have different associated access rights. For example, a ring tone electronic asset may allow unrestricted use of the ring tone after purchase, while a movie download may allow a limited number of viewings or unlimited access for a period of time.

In a particular illustrative embodiment, server system 118 generates an electronic storefront including a graphical user interface (GUI). The GUI includes multiple selectable indicators related to assets that are associated with media content that is received at CPE 104. Server system 118 can target specific assets to CPE 104 based on media content received at CPE 104.

In some embodiments, the GUI may include information describing selected assets 116 or describing a plurality of options related to obtaining the selected assets. The assets may be obtained by a purchase transaction, or by direct access without a purchase. For example, user-generated content (UGC) may be accessed freely by a user who is associated with a content library. The information may be personalized to a user or subscriber of CPE 104. In another particular embodiment, the information describing the asset or the information describing the plurality of options may be personalized to an account associated with CPE 104.

In an illustrative embodiment, CPE 104 may receive data that can be executed by a processor to generate a GUI, which may be provided to display device 112. The GUI can include multiple obtainable assets of different types, including UGC, and multiple related purchase options. CPE 104 may receive an input related to one or more of the multiple obtainable assets via remote control device 110. CPE 104 can send a request to server system 118 that is related to the input.

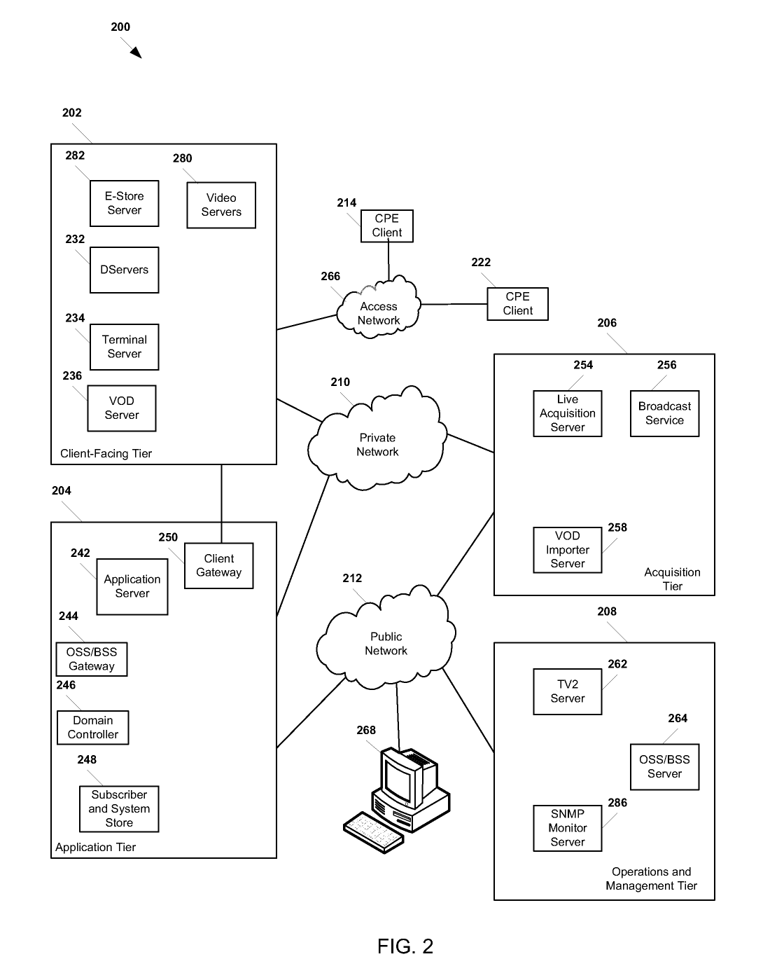

FIG. 2 is a block diagram of an illustrative embodiment of MCDN system 200 that may be used to present assets related to multimedia content. Although multimedia content is not limited to TV, VOD, or pay-per-view (PPV) programs, the depicted embodiments of MCDN system 200 and its capabilities are primarily described herein with reference to these types of multimedia content, which are interchangeably referred to herein as “multimedia content”, “multimedia content programs”, “multimedia programs” or, simply, “programs.”

The elements of MCDN system 200 illustrated in FIG. 2 depict network embodiments with functionality for delivering multimedia content to a set of one or more users. It is noted that different embodiments of MCDN system 200 may include additional elements or systems (not shown in FIG. 2 for clarity) as desired for additional functionality, such as data processing systems for billing, content management, customer support, operational support, or other business applications.

System 200 illustrated in FIG. 2 may include components and functionality illustrated in system 100 (see FIG. 1). In particular, server system 118 in FIG. 1 may be embodied by client-facing tier 202 and/or acquisition tier 206 in FIG. 2, while network 106 in FIG. 1 may represent at least one of access network 266, private network 210, and public network 212, shown in FIG. 2. Furthermore, CPE client 214, 222 in FIG. 2 may represent example embodiments of CPE 104, including remote control device 110 and display device 112, shown in FIG. 1.

As shown, system 200 can include client-facing tier 202, application tier 204, acquisition tier 206, and operations and management tier 208. Each tier 202, 204, 206, 208 is coupled to private network 210; to public network 212, such as the Internet; or to both private network 210 and public network 212. For example, client-facing tier 202 can be coupled to the private network 210. Further, application tier 204 can be coupled to private network 210 and to public network 212. Acquisition tier 206 can also be coupled to private network 210 and to public network 212. Additionally, operations and management tier 208 can be coupled to public network 212.

As illustrated in FIG. 2, the various tiers 202, 204, 206, 208 communicate with each other via private network 210 and the public network 212. For instance, client-facing tier 202 can communicate with application tier 204 and acquisition tier 206 via private network 210. Application tier 204 can communicate with acquisition tier 206 via private network 210. Further, application tier 204 can communicate with acquisition tier 206 and operations and management tier 208 via public network 212. Moreover, acquisition tier 206 can communicate with operations and management tier 208 via public network 212. In a particular embodiment, elements of application tier 204, including, but not limited to, client gateway 250, can communicate directly with client-facing tier 202.

Client-facing tier 202 can communicate with user equipment via access network 266. In an illustrative embodiment, CPE clients 214, 222 can be coupled to a local switch, router, or other device of the access network 266. Client-facing tier 202 may communicate with a first representative STB device via first CPE client 214 and with a second representative STB device via second CPE client 222 (STB devices not explicitly shown in FIG. 2). In a particular embodiment, first CPE client 214 can be located at a first customer premise, and second CPE client 222 can be located at a second customer premise. In another particular embodiment, the first representative STB device and the second representative STB device can be located at a single customer premise, both coupled to one of CPE clients 214, 222. CPE clients 214, 222 can include routers, local area network devices, modems, such as digital subscriber line (DSL) modems, any other suitable devices for facilitating communication between a STB device and access network 266, or any combination thereof.

In an exemplary embodiment, client-facing tier 202 can be coupled to CPE clients 214, 222 via fiber optic cables. In another exemplary embodiment, CPE clients 214, 222 can include DSL modems that are coupled to one or more network nodes via twisted pairs, and client-facing tier 202 can be coupled to the network nodes via fiber-optic cables. CPE clients 214, 222 may be configured to process data received via the access network 266, such as multimedia content provided by elements of MCDN system 200.

CPE clients 214, 222 can include MCDN STB devices; video gaming devices or consoles that are adapted to receive MCDN content; personal computers or other computing devices that are adapted to emulate STB device functionalities; any other device adapted to receive MCDN content and transmit data to an MCDN system via an access network; or any combination thereof.

In an exemplary, non-limiting embodiment, CPE clients 214, 222 can receive data, video, or any combination thereof, from client-facing tier 202 via access network 266 and render or display the data, video, or any combination thereof, at a display device to which it is coupled. In an illustrative embodiment, CPE clients 214, 222 can include tuners that receive and decode television programming signals or packet streams for transmission to display devices, such as TV monitors. Further, CPE clients 214, 222 may include a processor and a memory device (not shown in FIG. 2) that is accessible to the processor. In one embodiment, the memory device may store executable instructions, such as embodied by a computer program.

In an illustrative embodiment, client-facing tier 202 may include a means for communicating between client-facing tier 202 and access network 266 and between client-facing tier 202 and private network 210. In one example, the communication means in client-facing tier 202 may be a network switch or sub-system (not shown in FIG. 2) that is coupled to one or more data servers, such as D-servers 232, that store, format, encode, replicate, or otherwise manipulate or prepare video content for communication from client-facing tier 202 to CPE clients 214, 222. The communication means in client-facing tier 202 can also be coupled to terminal server 234 that provides terminal devices with a point of connection to MCDN system 200 via client-facing tier 202. In a particular embodiment, communication means in client-facing tier 202 can be coupled to VOD server 236 that stores or provides VOD content imported by MCDN system 200. Further, the communication means in client-facing tier 202 may be coupled to one or more video servers 280 that receive video content and transmit the content to CPE clients 214, 222 via access network 266. The communication means in client-facing tier 202 can also be coupled to electronic store server 282 that stores and provides data related to purchasable assets to user devices, such as CPE clients 214, 222.

In an illustrative embodiment, client-facing tier 202 can communicate with a large number of clients, such as representative CPE clients 214, 222, over a wide geographic area, such as a metropolitan area, a viewing area, a statewide area, a regional area, a nationwide area or any other suitable geographic area, market area, or subscriber or customer group that can be supported by networking client-facing tier 202 to numerous CPE clients. In a particular embodiment, the communication means in client-facing tier 202, or any portion thereof, can include a multicast router or switch that communicates with multiple CPE clients via a multicast-enabled network.

As illustrated in FIG. 2, application tier 204 can communicate with both private network 210 and public network 212. Application tier 204 can include a means for communicating that can be coupled to application server 242 and to operations systems and support/billing systems and support (OSS/BSS) gateway 244. In a particular embodiment, application server 242 can provide applications to CPE clients 214, 222 via access network 266, which enable CPE clients 214, 222 to provide functions, such as interactive program guides, video gaming, display, messaging, processing of VOD material and other MCDN multimedia content, etc. In an illustrative embodiment, application server 242 can provide location information to CPE clients 214, 222. In a particular embodiment, OSS/BSS gateway 244 includes OSS data, as well as BSS data. In one embodiment, OSS/BSS gateway 244 can provide or restrict access to OSS/BSS server 264 that stores operations and billing systems data.

The means for communicating in application tier 204 can be coupled to domain controller 246 that provides Internet access, for example, to users at their computers 268 via the public network 212. For example, domain controller 246 can provide remote Internet access to IPTV account information, e-mail, personalized Internet services, or other online services via public network 212. In addition, the means for communicating in application tier 204 can be coupled to subscriber and system store 248 that includes account information, such as account information that is associated with users who access MCDN system 200 via private network 210 or public network 212. In an illustrative embodiment, subscriber and system store 248 can store subscriber or customer data and create subscriber or customer profiles that are associated with IP addresses, stock-keeping unit (SKU) numbers, other identifiers, or any combination thereof, of corresponding CPE clients 214, 222. In another illustrative embodiment, subscriber and system store 248 can store data associated with capabilities of STB devices associated with particular customers, such as UGC.

In a particular embodiment, application tier 204 can include client gateway 250 that communicates data directly to client-facing tier 202. In this embodiment, client gateway 250 can be coupled directly to client-facing tier 202. Client gateway 250 can provide user access to private network 210 and other tiers coupled thereto. In an illustrative embodiment, CPE clients 214, 222 can access MCDN system 200 via access network 266, using information received from client gateway 250. User devices can access client gateway 250 via access network 266, and client gateway 250 can allow such devices to access private network 210 once the devices are authenticated or verified. Similarly, client gateway 250 can prevent unauthorized devices, such as hacker computers or stolen CPE from accessing private network 210, by denying access to these devices beyond access network 266.

For example, when a first representative CPE client 214 accesses client-facing tier 202 via access network 266, client gateway 250 can verify subscriber information by communicating with subscriber and system store 248 via private network 210. Further, client gateway 250 can verify billing information and status by communicating with OSS/BSS gateway 244 via private network 210. In one embodiment, OSS/BSS gateway 244 can transmit a query via public network 212 to OSS/BSS server 264. After client gateway 250 confirms subscriber and/or billing information, client gateway 250 can allow CPE client 214 to access MCDN content and VOD content at client-facing tier 202. If client gateway 250 cannot verify subscriber information for CPE client 214, e.g., because it is connected to an unauthorized twisted pair, client gateway 250 can block transmissions to and from CPE client 214 beyond access network 266.

In FIG. 2, acquisition tier 206 may include a means for communication (not shown in FIG. 2) with private network 210, that can also communicate with operations and management tier 208 via public network 212. In a particular embodiment, the communication means in acquisition tier 206 can be coupled to live acquisition server 254 that receives or acquires television content, movie content, advertisement content, other video content, or any combination thereof, from broadcast service 256, such as a satellite acquisition system or satellite head-end office. In a particular embodiment, live acquisition server 254 can transmit content to the communication means in acquisition tier 206, which can transmit the content to client-facing tier 202 via private network 210.

In an illustrative embodiment, multimedia content can be transmitted to D-servers 232, where it can be encoded, formatted, stored, replicated, or otherwise manipulated and prepared for communication from video server(s) 280 to CPE clients 214, 222. Client-facing tier 202 can receive content from video server(s) 280 and communicate the content to CPE 214, 222 via access network 266. STB devices can receive the content via CPE 214, 222, and can transmit multimedia content to television monitors (not shown in FIG. 2). In an illustrative embodiment, video or audio portions of the multimedia content can be streamed to CPE clients 214, 222.

Further, acquisition tier 206 can be coupled to a VOD importer server 258 that receives and stores television or movie content received at acquisition tier 206 and communicates the stored content to VOD server 236 at client-facing tier 202 via private network 210. Additionally, at acquisition tier 206, VOD importer server 258 can receive content from one or more VOD sources outside MCDN system 200, such as movie studios and programmers of non-live content. VOD importer server 258 can transmit the VOD content to acquisition tier 206, which can communicate the material to client-facing tier 202 via private network 210. The VOD content can be stored at one or more servers, such as VOD server 236.

When users issue requests for VOD content via CPE clients 214, 222, the requests can be transmitted over access network 266 to VOD server 236, via client-facing tier 202. Upon receiving such requests, VOD server 236 can retrieve the requested VOD content and transmit the content to CPE clients 214, 222 across access network 266. In an illustrative embodiment, video or audio portions of VOD content can be streamed to CPE clients 214, 222.

In FIG. 2, operations and management tier 208 can include a means for communication (not shown in FIG. 2) that conducts communication between operations and management tier 208 and public network 212. The communication means in operations and management tier 208 may be coupled to TV2 server 262. Additionally, communication means in operations and management tier 208 can be coupled to OSS/BSS server 264 and to simple network management protocol (SNMP) monitor server 286 that monitors network devices within or coupled to MCDN system 200. In a particular embodiment, the communication means in operations and management tier 208 can communicate with acquisition tier 206 via public network 212.

In an illustrative embodiment, live acquisition server 254 can transmit content to acquisition tier 206, which can transmit the content to operation and management tier 208 via public network 212. In this embodiment, operations and management tier 208 can transmit the content to TV2 server 262 for display to users accessing the user interface at TV2 server 262. For example, a user can access TV2 server 262 using personal computer 268 coupled to public network 212.

In a particular illustrative embodiment, client-facing tier 202 can provide media content, such as video content, to CPE client 214. The media content can include a selectable trigger, which may be provided by CPE client 214 to a display device as a popup within a video display. Client-facing tier 202 may receive data related to selection of the selectable trigger. In response to receiving the data, electronic store server 282 may provide a GUI including an electronic storefront to CPE client 214 for display at a display device, such as a TV monitor (not shown in FIG. 2). The electronic storefront can include data related to multiple purchasable assets as well as multiple options for purchasing one or more of the assets.

In another particular illustrative embodiment, CPE client 214 receives media content including an embedded trigger. CPE client 214 identifies the embedded trigger and provides a popup to a TV monitor that is related to the embedded trigger. The popup can include information related to a particular promotion and an invitation to access an electronic storefront. A user may utilize a remote control device to request the electronic storefront. CPE client 214 may receive an input from the remote control device and transmit a request to client-facing tier 202 for the electronic storefront. The request may include an identifier related to the selected media content, an identifier related to CPE client 214, an account identifier associated with CPE client 214, an identifier associated with the electronic storefront, or any combination thereof. In a particular embodiment, in response to sending the request, CPE client 214 may receive a GUI that includes an electronic storefront that has multiple purchasable assets and multiple selectable payment options. CPE client 214 may provide the GUI to a TV monitor or other type of display device such as display device 112 (FIG. 1). In one embodiment, CPE client 214 can receive data that can be executed by a processor to generate a GUI that includes an electronic storefront that has multiple purchasable assets and multiple selectable payment options. CPE client 214 can provide the generated GUI to a display device for display. A user may utilize a remote control device to purchase one or more assets and to select a payment option related to the purchase. CPE client 214 may send an asset identifier and purchase information to electronic-store server 282 for fulfillment.

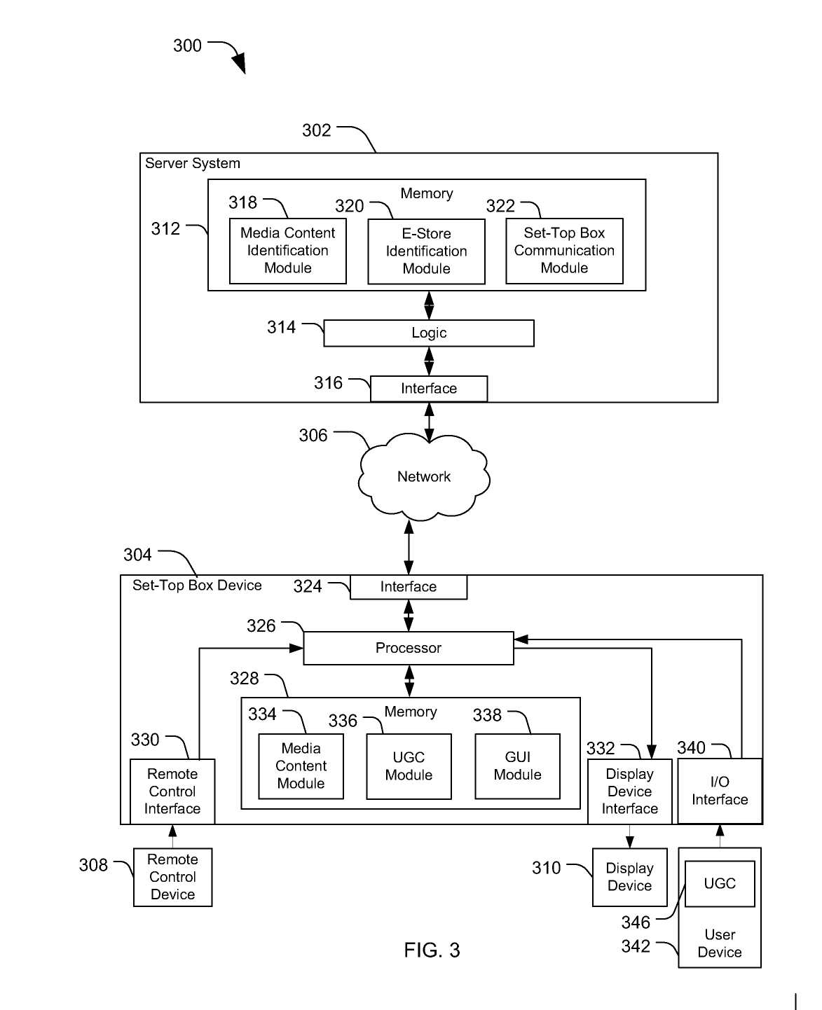

FIG. 3 is a block diagram of a third particular illustrative embodiment of system 300 to present assets related to media content. System 300 includes server system 302 that communicates with CPE at a client system, represented in FIG. 3 by STB device 304, via network 306, which may be the public Internet or an MCDN. System 300 may depict an embodiment of system 100 (see FIG. 1). It is noted that server system 302 in FIG. 3 may represent an embodiment of the functionality represented by server system 118 in FIG. 1. Network 306 in FIG. 3 may similarly depict an embodiment of network 106 in FIG. 1. Furthermore, STB device 304 in FIG. 3 may embody an example of CPE 104 in FIG. 1.

Server system 302 includes interface 316 to network 306, processing logic 314 and memory 312 that is accessible to processing logic 314. In a particular embodiment, memory 312 includes media content identification module 318 that can be executed by processing logic 314 to identify media content received at STB device 304. Media content identification module 318 may also be used to transmit media content to STB device 304. The media content may include an embedded selectable trigger, which can be executed at STB device 304 to generate a popup within the video at display device 310. Memory 312 may also include electronic store (e-store) identification module 320 that can be executed by processing logic 314 to identify assets. E-store identification module 320 may also be executed by processing logic 314 to generate an electronic storefront, including a GUI presenting the identified assets. Memory 312 may also include STB communication module 322 that can be executed by processing logic 314 to communicate with STB device 304 to receive requests for an electronic storefront related to media content and to communicate the generated electronic storefront to STB device 304. In a particular illustrative embodiment, STB communication module 322 may also receive data related to purchase orders and payment option selections from STB device 304.

STB device 304 may include interface 324 to network 306. STB device 304 may also include processor 326 coupled to interface 324 and memory 328 that is accessible to processor 326. STB device 304 may also include remote control interface 330 that communicates with remote control device 308 and display device interface 332 that communicates with display device 310. In a particular embodiment, memory 328 includes media content module 334 that is executable by processor 326 to receive media content from server system 302 (or from another content source) via network 306. Memory 328 may include UGC module 336, which may store items of UGC. A user may upload UGC to UGC module 336, as will be described in detail herein. Memory 328 may also include GUI module 338 that is executable by processor 326 to receive instructions related to an electronic storefront and to generate a GUI that can be provided to display device 310 that includes one or more selectable indicators related to obtainable assets, including UGC.

STB device 304 may further include I/O interface 340 for coupling to user device 342. User device 342 may originate or store UGC 346. In various embodiments, user device 342 may be a media player, a cell phone, a camera device, a recording device, or a combination thereof. Examples of UGC 346 thereby include images, audio, video, text, graphics, or a combination thereof. As shown in FIG. 3, user device 342 may be configured to connect with I/O interface 340 for the purpose of uploading UGC 346 to UGC module 336. UGC module 336 may be configured to store UGC, such as UGC 346, and/or upload UGC to server system 302.

In different embodiments, memory 328 may include a trigger selection module (not shown in FIG. 3) that is executable by processor 326 to identify an embedded selectable trigger within the media content and to generate a selectable popup within the video at the display device based on the embedded trigger. The trigger selection module may also be executed by processor 326 to receive a selection related to the selectable popup via remote control device 308 and to communicate data related to the selection to server system 302 via the network.

In a particular illustrative embodiment, e-store module 320 may be executed to select an electronic storefront from a plurality of stored electronic storefronts based on media content received at STB device 304. In another particular illustrative embodiment, e-store identification module 320 can be executed to generate the electronic storefront dynamically, such that the GUI includes an electronic storefront having a first selectable element related to a first asset and a second selectable element related to a second asset (both selected based on the media content). The GUI can also include multiple payment options that are related to a first selectable element and a second selectable element. In a particular illustrative embodiment, the multiple payment options can include an electronic coupon payment option, account billing option to bill a subscriber account associated with the destination device (i.e., the STB device), a credit card option, a debit card option, other payment options, or any combination thereof.

In a particular illustrative embodiment, the STB device 304 receives media content including an embedded trigger from server system 302. STB device 304 identifies the embedded trigger and provides the media content and a popup based on the embedded trigger to display device 310. STB device 304 receives an input from remote control device 308 that is related to the popup. STB device 304 sends a request to server system 302 based on the input. The request may include an identifier related to the media content, an identifier associated with STB device 304, a subscriber account identifier, an electronic storefront identifier, other information, or any combination thereof. STB device 304 receives data related to an electronic storefront based on the request, and provides a user interface to display device 310 that includes the electronic storefront. The electronic storefront includes one or more selectable indicators related to obtainable assets. The electronic storefront may also include one or more payment options for purchasing selected obtainable assets. STB device 304 receives a selection of at least one indicator and a selected payment option and sends data related to the selection and the selected payment option to server system 302 to complete a purchase transaction.

In a particular embodiment, if the obtained asset is an electronic asset, server system 302 may provide instructions for downloading the asset, may send the obtained asset, may perform other actions, or any combination thereof. If the obtained asset is a tangible object, server system 302 may transmit a purchase order fulfillment request to a fulfillment center (not shown) to complete the packaging and shipping of the desired asset. Server system 302 may also notify an inventory system (not shown) to update inventory data based on the obtained asset.

In certain embodiments, media content information module 318 may include or may be configured to access a library of user-specific UGC. The UGC may be uploaded from UGC module 336 to server system 302. Access to the library of user-specific UGC may be enabled for third-parties, for example, by using an electronic address book, as will be described in detail below.

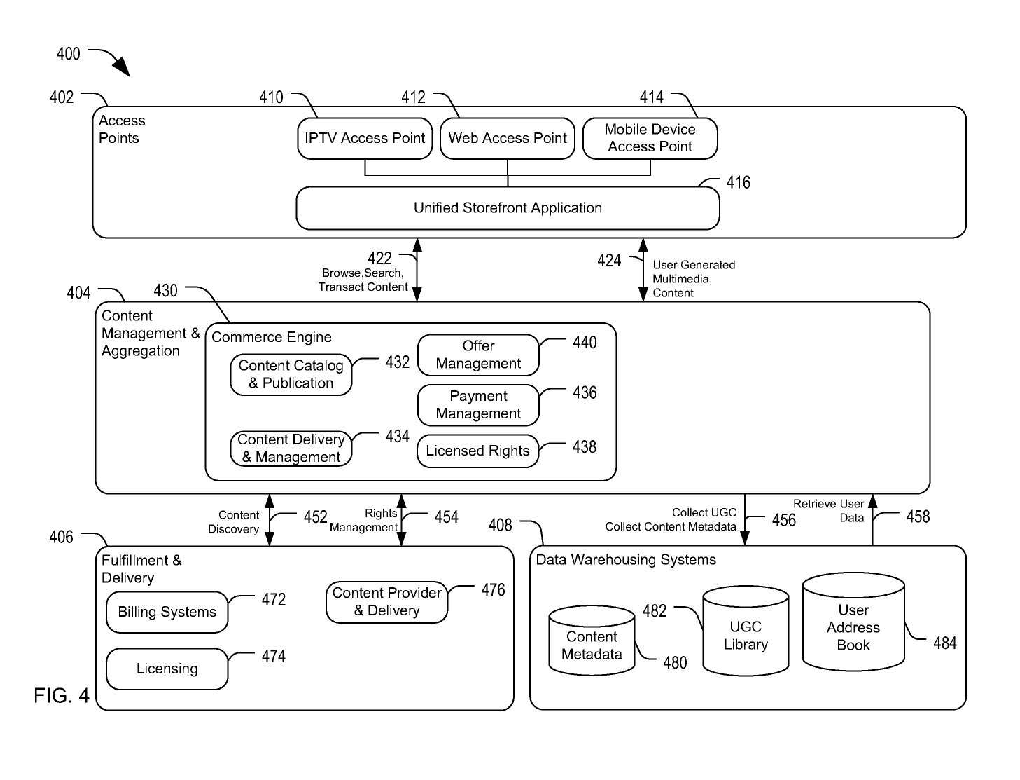

FIG. 4 is a block diagram of an illustrative embodiment of system 400 to present recommendations for assets related to media content. System 400 may include access points module 402, content management and aggregation module 404, fulfillment and delivery module 406, and data warehousing systems 408, as will be described in detail below.

System 400 may include one or more of a plurality of access points in access points module 402, which may include IPTV access point 410, web access point 412, and mobile device access point 414. Access points module 402 may also include unified storefront (USF) application 416. USF application 416 may send data related to a storefront display via access points 410, 412, 414 to a user device that is signed on, for example with a registered account for an MCDN. USF application 416 may further enable a user to upload content, such as UGC, via access points 410, 412, 414.

Access points module 402 may communicate with content management and aggregation module 404 via a plurality of communication links. In particular, access points module 402 may transfer user input along with corresponding displayed information for browsing, searching and transacting content, represented in FIG. 4 as 422, with content management and aggregation module 404. In some embodiments, 422 may represent information exchanged via a user interface provided by USF application 416. In addition, user-generated multimedia content link 424 may provide communication and transfer of UGC between modules 402 and 404.

System 400 may also include content management and aggregation module 404 having commerce engine 430. In a particular embodiment, commerce engine 430 includes content catalog and publication module 432, which may identify assets that are available to be offered for sale. Commerce engine 430 may also include content delivery and management module 434. For example, content delivery and management module 434 may query content providers, such as content provider and delivery module 476, to identify assets that are available for purchase. Content catalog and publication module 432 may also provide information identifying the available assets to offer management 440 to allow offer rules related to the assets to be configured. Content delivery and management module 434 may manage delivery of obtainable assets, including UGC, to and/or from user devices. Content delivery and management module 434 may send an access grant message to a content provider after payment for an asset has been received and approved by payment management 436. The grant message may authorize the content provider to send the content of the purchased asset to the purchasing user device or another user device. Commerce engine 430 may also include licensed rights module 438. Licensed rights module 438 may implement rules to ensure the license rights associated with digital assets are complied with. Licensed rights module 438 may obtain licenses from third-parties via licensing module 474.

In a particular embodiment, fulfillment and delivery module 406 may include a variety of fulfillment modules including content provider and delivery module 476, and licensing module 474. Fulfillment and delivery module 406 may include one or more transaction application modules, such as billing systems module 472. Billing systems module 472 may receive data related to the purchase of assets, e.g., billing events data, and may determine a charge for the purchase based on the data. Billing systems module 472 may prepare a bill to charge a subscriber for the purchase of an asset. In one example, billing systems module 472 may add the charge to a unified subscriber bill for communication services, such as wireless telephone service, telephone service, television service (e.g., IPTV service), Internet access service, other communication services, or any combination thereof. Licensing module 474 may enforce licenses and encode content to prevent unauthorized access.

Content management and aggregation module 404 may communicate with fulfillment and delivery module 406 via a plurality of communication links. Representative examples of the communication links may include content discovery communication link 452 and rights management communication link 454. Content management and aggregation module 404 may also communicate with data warehousing systems 408 via a plurality of communication links, such as link 456 and link 458. Link 456 may provide for the collection of UGC and/or content metadata from content management and aggregation module 404. Data warehousing systems 408 may provide user data, such as UGC, via link 458. In certain embodiments, UGC content may be provided via link 458 in response to a query.

As shown in FIG. 4, data warehousing systems 408 may include various data stores, or databases, including content metadata 480, UGC library 482, and user address book 484. Content metadata 480 may include information on multimedia content, including UGC, or assets consumed by subscribers or consumers, and may be indexed or categorized for various criteria, as described above. UGC library 482 may represent a repository for UGC that has been uploaded via user-generated multimedia content link 424. UGC library 482 may include UGC specific to different users. UGC library 482 may further be indexed, or related to UGC metadata stored in content metadata 480.

User address book 484 may represent an electronic address book, including entries for individuals. The individual entries may include contact information, such as network addresses or email addresses. In certain embodiments, user address book 484 may represent an electronic address book provided by a third party, for example, as a network service. In that sense, user address book 484 may not be physically hosted within data warehousing systems 408, but yet represent an accessible electronic address book. Databases 480, 482, 484 may be utilized to store UGC and to allow a user to designate specific recipients for accessing UGC, among other uses. In one embodiment, content delivery and management 434 may access data warehousing systems 408 in order to retrieve multimedia assets included in a collection of UGC specified by a user of USF application 416. The UGC may be made accessible to at least one specified entry in user address book 484. The individual associated with the specified entry may access the UGC, or the UGC may be sent to the individual based on contact information included in the entry.

During operation of a particular embodiment, content delivery and management module 434 may facilitate the collection and delivery of multimedia content, including UGC, via USF application 416. Multimedia content, including at least one obtainable multimedia asset, may be presented to the user via USF application 416. The presentation may be in the form of a GUI, configured to allow selection and purchase of rights to multimedia assets. As used herein, “obtainable” describes multimedia assets for which certain rights are available, or may be offered for purchase, to a user (e.g., a consumer or subscriber). The rights that may be purchased, i.e., obtained, may include rental or ownership rights to multimedia assets. The rights may include digital rights that may be restricted by user, duration, number of playbacks, time/date of playback, playback location, playback device, playback quality, copy or forward ability, or other limitations. Thus, as used herein, a “purchase”, a “purchase transaction”, or a “purchase request” for an asset refers to obtaining certain rights to the asset, which may or may not be unrestricted ownership rights.

The user may select and provide user input indicating a desire to purchase the selected asset using USF application 416. USF application 416 may then initiate a purchase transaction, by obtaining billing information, and forward a purchase request, as described in detail above. After receiving approval for the purchase of the asset, USF application 416 may provide the content of the electronic asset to the user via at least one of IPTV access point 410, web access point 412, and mobile device access point 414. In some instances, USF application 416 provides access via a suitable interface based on the asset type. For example, IPTV-related assets may be provided via IPTV access point 410, an Internet asset may be available via web access point 412, and a mobile asset may be available via mobile device access point 414. In certain embodiments, electronic assets may be offered and/or made available by at least two of IPTV access point 410, web access point 412, and mobile device access point 414.

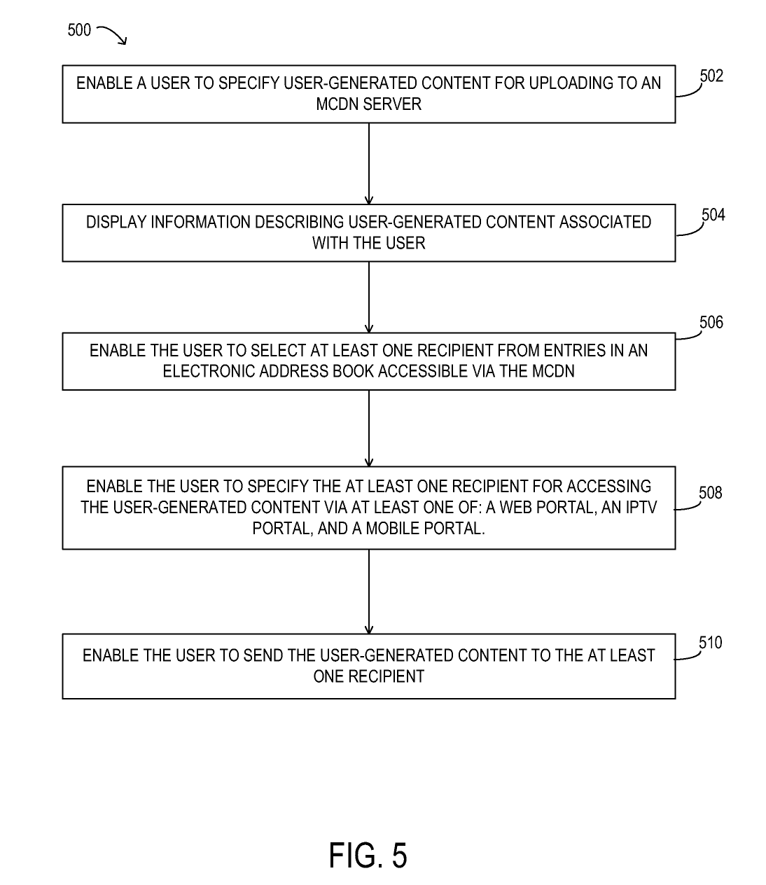

In reference to FIG. 5, an embodiment of method 500 for presenting assets, including UGC, related to multimedia content is depicted. Method 500 may be executed in various embodiments of an MCDN, such as systems 100, 200, 300, and 400, depicted in FIGS. 1-4, respectively.

A user may be enabled to specify UGC for uploading to an MCDN server (operation 502). The UGC may be uploaded to the MCDN server from a user device, such as user device 342 (see FIG. 3). The user may be associated with an MCDN user account. The uploaded UGC may be included in a repository of UGC, such as UGC library 482 (see FIG. 4). The user may further upload the UGC to the MCDN server. Information describing UGC associated with the user may be displayed (operation 504). The information may include content metadata describing the UGC, such as from content metadata 480 (see FIG. 4). The user may be enabled to select specific items in the UGC based on the displayed information, such as particular multimedia assets.

The user may then be enabled to select at least one recipient from entries in an electronic address book accessible via the MCDN (operation 506). As noted above, the electronic address book may be externally provided via a network connection by a third-party service provider, which may be a different business entity than the provider of the MCDN. The network connection may be a public network connection, such as via the Internet. The electronic address book may be accessed remotely via a network connection that may or may not be within the MCDN. The user may select the recipient(s) by accessing the electronic address book. The electronic address book may include auto-populated entries for MCDN user accounts. In this manner, the electronic address book may enable selecting MCDN users as recipients. The entries in the electronic address book may also include additional entries for non-MCDN user accounts.

The user may be enabled to specify the at least one recipient for accessing the UGC via at least one of a web portal, an IPTV portal, and a mobile portal (operation 508). The UGC may be retrieved from a repository and made available for access by at least one of the portal(s). The recipient may be authorized to access only the UGC specified by the user, as described above. In certain embodiments, the recipient(s) may retrieve the UGC. The user may be enabled to send the UGC to the at least one recipient (operation 510). The UGC, or the selected portion of the UGC, may be made available to the recipient based on a network address specified in the corresponding entry in the electronic address book. The network address may include at least one of: an email address, an MCDN network specifier, and an Internet-protocol address.

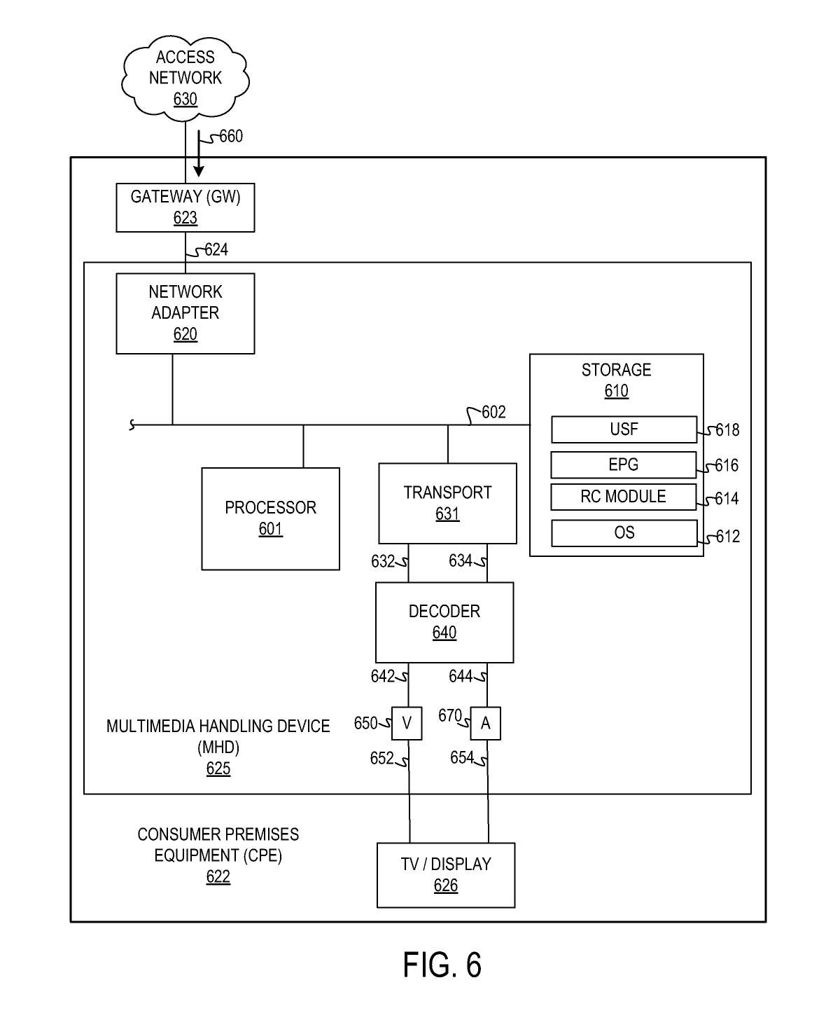

Referring now to FIG. 6, a block diagram illustrating selected elements of an embodiment of MHD 625 is presented. In FIG. 6, MHD 625 is shown as a functional component of CPE 622 along with gateway (GW) 623 and display 626, independent of any physical implementation. In particular, it is noted that CPE 622 may be any combination of GW 623, MHD 625 and display 626. In some cases, MHD 625 represents an embodiment of an STB device, such as STB device 304 (see FIG. 3).

In the embodiment depicted in FIG. 6, MHD 625 includes processor 601 coupled via shared bus 602 to storage media collectively identified as storage 610. MHD 625, as depicted in FIG. 6, further includes network adapter 620 that interfaces MHD 625 to local area network (LAN) 624 and through which MHD 625 receives multimedia content 660. GW 623 is shown providing a bridge between access network 630 and LAN 624, and receiving multimedia content 660 from access network 630.

In embodiments suitable for use in IP based content delivery networks, MHD 625, as depicted in FIG. 6, may include transport unit 631 that assembles the payloads from a sequence or set of network packets into a stream of multimedia content. In coaxial based access networks, content may be delivered as a stream that is not packet based and it may not be necessary in these embodiments to include transport unit 631. In a co-axial implementation, however, clients, such as CPE 622, may utilize tuning resources (not explicitly depicted in FIG. 6) to “filter” desired content from other content that is delivered over the coaxial medium simultaneously and these tuners may be provided in MHDs 625. The stream of multimedia content received by transport unit 631 may include audio information and video information and transport unit 631 may parse or segregate the two to generate video stream 632 and audio stream 634 as shown.

Video and audio streams 632 and 634, as output from transport unit 631, may include audio or video information that is compressed, encrypted, or both. A decoder unit 640 is shown as receiving video and audio streams 632 and 634 and generating native format video and audio streams 642 and 644. Decoder 640 may employ any of various widely distributed video decoding algorithms including any of the Motion Pictures Expert Group (MPEG) standards, or Windows Media Video (WMV) standards including WMV 9, which has been standardized as Video Codec-1 (VC-1) by the Society of Motion Picture and Television Engineers. Similarly decoder 640 may employ any of various audio decoding algorithms including Dolby® Digital, Digital Theatre System (DTS) Coherent Acoustics, and Windows Media Audio (WMA).

The native format video and audio streams 642 and 644 as shown in FIG. 6 may be processed by encoders/digital-to-analog converters (encoders/DACs) 650 and 670 respectively to produce analog video and audio signals 652 and 654 in a format compliant with display 626, which itself may not be a part of MHD 625. Display 626 may comply with National Television System Committee (NTSC), Phase Alternating Line (PAL) or any other suitable television standard.

Storage 610 encompasses persistent and volatile media, fixed and removable media, and magnetic and semiconductor media. Storage 610 is operable to store instructions, data, or both. Storage 610 as shown may include sets or sequences of instructions, namely, an operating system 612, a remote control (RC) application program identified as RC module 614, an electronic programming guide (EPG) 616, and USF 618. Operating system 612 may be a UNIX or UNIX-like operating system, a Windows® family operating system, or another suitable operating system.

EPG 616 represents a guide to the multimedia content provided to CPE 622 via MCDN system 200 (see FIG. 2), and may be shown to the user as an element of the user interface. The user interface may include a plurality of menu items arranged according to one or more menu layouts, which enable a user to operate MHD 625. The user may operate the user interface, including EPG 616, using a remote control in conjunction with RC module 614.

To the maximum extent allowed by law, the scope of the present disclosure is to be determined by the broadest permissible interpretation of the following claims and their equivalents, and shall not be restricted or limited to the specific embodiments described in the foregoing detailed description.

What is claimed is:

1. A method for distributing multimedia content in a multimedia content distribution network (MCDN), comprising:
displaying information describing user-generated content associated with a user of the MCDN;
enabling the user to select at least one recipient from entries in an electronic address book accessible via the MCDN; and
enabling the user to authorize the at least one recipient to access the user-generated content via at least one of: a web portal, an IPTV portal, and a mobile portal.

2. The method of claim 1, wherein the user is associated with a registered account for the MCDN.

3. The method of claim 1, further comprising:
enabling the user to specify a portion of the user-generated content for uploading to an MCDN server.

4. The method of claim 3, wherein the uploaded content is stored in a user-generated content library.

5. The method of claim 4, wherein the MCDN server is configured to display the selected at least one item to the at least one recipient via at least one of: the web portal, the IPTV portal, and the mobile portal.

6. The method of claim 1, further comprising:
receiving user input selecting at least one item in the user-generated content,
wherein the at least one recipient is only authorized to access the selected at least one item.

7. The method of claim 1, further comprising:
enabling the user to send the user-generated content to the at least one recipient.

8. The method of claim 1, wherein the electronic address book includes auto-populated entries for MCDN users.

9. The method of claim 1, wherein the electronic address book includes additional entries for non-MCDN users.

10. The method of claim 1, wherein the electronic address book is provided by a business entity different from the provider of the MCDN.

11. A service for distributing multimedia content in a multimedia content distribution network (MCDN), comprising:
displaying information indicative of uploaded user-generated content associated with a user of the MCDN;
enabling the user to select an entry in an electronic address book accessible via the MCDN; and
enabling the user to specify the entry for receiving the user-generated content via an IPTV portal.

12. The service of claim 11, wherein the user is associated with a registered account for the MCDN.

13. The service of claim 11, further comprising:
enabling the user to select an item of user-generated content from the displayed information.

14. The service of claim 13, further comprising:
making the selected item of user-generated content available to the entry using a network address specified in the electronic address book.

15. The service of claim 14, wherein the network address includes an email address.

16. The service of claim 14, wherein the network address includes an MCDN network specifier.

17. The service of claim 14, wherein the network address includes an Internet-protocol address.

18. A computer-readable memory media, including instructions for implementing a multimedia content distribution network (MCDN), said instructions executable to:
enable a user to select a user-generated multimedia asset via at least one of an access portal included in the group: a web portal, an Internet-protocol television portal provided by the MCDN, and a mobile portal; and
enable the user to specify an entry in an electronic address book for receiving the selected multimedia asset.

19. The memory media of claim 18, further comprising instructions executable to:
display information indicative of the user-generated multimedia asset to the user.

20. The memory media of claim 18, further comprising instructions executable to:
enable the user to upload the multimedia asset via at least one of the access portals; and
store the uploaded multimedia asset in a user-generated multimedia content library.

21. The memory media of claim 18, further comprising instructions executable to:
access the electronic address book remotely via a network connection.

22. The memory media of claim 21, wherein the network connection is within the MCDN.
